(19) United States
(12) Patent Application Publication
(10) Pub. No.: US 2006/0038780 A1
(43) Pub. Date: Feb. 23, 2006

(54) System and method for automatically establishing handedness settings of mouse-like input device

(76) Inventors: John Carl Mese, Cary, NC (US); Rod David Waltermann, Rougemont, NC (US); Arnold S. Weksler, Raleigh, NC (US)

Correspondence Address: LENOVO (US) IP Law, Mail Stop ZHHA/B675/PO Box 12195, 3039 Cornwallis Road, RTP, NC, 27709-2195, US

(21) Appl. No.: 10/922,416

(22) Filed: Aug. 20, 2004

(51) Int. Cl. G09G 5/08

(52) U.S. Cl. 345/163

(57) ABSTRACT

Handedness settings for a mouse-like point and click input device are automatically established based on signals that are generated when a user rests his hand on the device.

### FIELD OF THE INVENTION

The present invention relates generally to automatically establishing handedness settings of a mouse-like computer pointing and clicking input device.

### BACKGROUND

Computer pointing and input devices such as mice, joysticks, and touch pads with left and right entry buttons typically have more than a single element that can be manipulated to send signals to a host computer. Specifically, two input buttons, usually referred to as a left button and a right button owing to their orientation on the input device, are provided that a user can click to invoke respective functions.

In typical applications, the left button can be used in drag and drop operations and can be double clicked to open files, whereas the right button usually enables opening files with a single click. Of course, the buttons can have other functions as is known in the art.

Because most computer users are right-handed, it is generally the case that more frequent functions are assigned to the button which commonly is expected to rest under the index finger of a right-handed user. But left-handed users usually rest their index fingers over the opposite button, so most operating systems allow left-handed users to access a control panel and switch button functions in software, with typically left button functions switched to the right button and vice-versa. As understood herein, requiring a user to take affirmative steps to establish the “handedness” of a pointing device is inconvenient to the user.

IBM's U.S. Pat. No. 5,841,425 discloses a system for automatically sensing handedness and establishing button functions in response that uses a light sensing scheme. The present invention recognizes that this is effective, but that other inventive ways can also advantageously be used to sense handedness and establish button functions in response by, e.g., using pre-existing devices already present in the computer for undertaking functions other than establishing handedness.

### SUMMARY OF THE INVENTION

The invention may be implemented as one or more of a computer-executed method, a computer system, a computer program device, and a service. In one implementation a method includes receiving a signal from a mouse-like input device of a computer. The signal is generated only when a user makes resting tactile contact with the input device. Based on the signal, handedness settings are automatically established.

It is to be understood that while “handedness settings” refer below to the functions assigned to click elements, “handedness” or “handedness settings” more generally refer to functions that may be assigned to other types of input devices and/or to other aspects of computer systems.

A method includes receiving a signal from a mouse-like input device of a computer. The signal is generated when a user makes resting tactile contact with the input device. The method also includes, based at least in part on the signal, automatically establishing at least one handedness setting.

In non-limiting implementations the mouse-like input device includes at least two buttons, and the handedness settings are established for the buttons based on a signal that is generated when a user makes resting tactile contact with the mouse-like input device. The mouse-like input device may be a mouse or a trackball or a joystick.

As set forth further below, in some embodiments the mouse-like input device includes an input device housing and plural pressure sensors supported in the housing. The sensors generate signals when a user rests a hand on the housing. The signals are used by a processor to establish handedness settings. The processor may be in the mouse housing, in which case the processor defines button identities to a computer based on the signals from the pressure sensors. Or, the processor may be the processor of the host computer, in which case processor assigns at least one function to each button based on the signals from the pressure sensors.

In another alternate embodiment, the mouse-like input device includes a fingerprint reader for use in correlating a fingerprint image from the reader to a left finger or right finger to establish the handedness setting.

In another alternate embodiment, a cursor positioning wheel is on the housing, and signals from the cursor-positioning wheel can be used to establish the handedness setting.

In another aspect, a computer input system for inputting signals to a computer housing holding at least one processor includes a mouse-like housing and a mouse-like pointing device on the mouse-like housing. At least two click elements are on the mouse-like housing. Also, plural pressure sensors are on the mouse-like housing for generating signals when a user rests a hand on the housing, with the signals being useful for automatically establishing respective functions for the click element.

In still another aspect, a mouse-like input device includes a fingerprint reader useful for correlating a fingerprint image from the reader to a left finger or right finger to establish at least one handedness setting for the input device.

In yet another aspect, a service includes receiving a fingerprint signal generated from at least one mouse-like input device. The service also includes returning to a user computer associated with the mouse-like input device a signal representing “left” or “right” to facilitate establishing handedness settings for click elements associated with the mouse-like input device.

In another aspect, a computer program device is executable by a processor for automatically establishing at least one handedness setting for a mouse-like input device based on signals that are generated when a user makes tactile contact with the mouse-like input device.

In yet another aspect, a computer wrist rest has a wrist rest body and plural pressure sensors disposed in the body. The sensors output signals representative of a user resting a portion of the user's body on the wrist rest, with the signals being useful in determining handedness.

In another aspect, a computer input system for inputting signals to a computer housing holding at least one processor includes a mouse-like housing and at least two click elements on the mouse-like housing. A cursor positioning element such as a wheel rotatably mounted on the mouse-like housing generates signals that are used by a processor for automatically establishing respective functions for the click element.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a top plan view of a mouse-like input device;

FIG. 3 is a flow chart showing the logic for automatically establishing handedness according to a first embodiment;

FIG. 4 is a flow chart showing the logic for automatically establishing handedness according to a second embodiment; and

FIG. 5 is a flow chart showing the logic for automatically establishing handedness according to a third embodiment.

### DETAILED DESCRIPTION OF THE PREFERRED EMBODIMENT

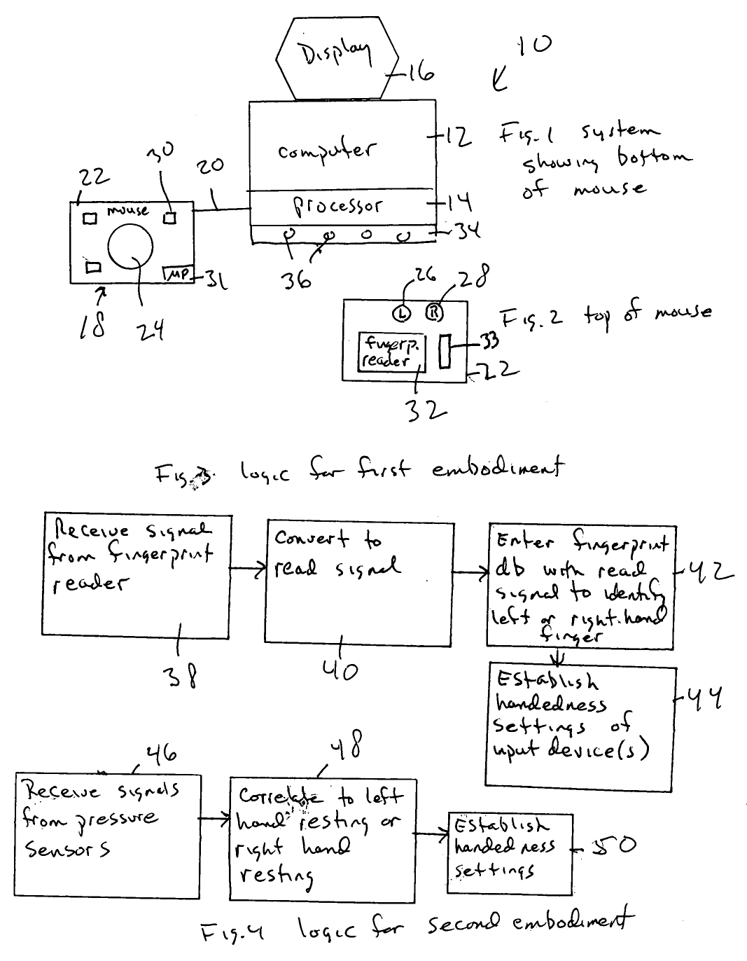

Referring initially to FIG. 1, a computing system is shown, generally designated 10, that includes a computer 12 having a processor 14 and a display 16. The computer 12 can be any suitable computer, e.g., a personal computer or larger (mainframe), a laptop computer, a notebook computer or smaller, etc. For instance, the computer 12 without limitation can be an IBM Thinkpad® or ThinkCentre™ computer. The processor 14 may access computer programs on program devices such as but not limited to floppy diskettes, hard disk drives, optical disks, and solid state memory to execute the logic herein, which can alternatively be executed by the below-described processor in the mouse-like input device.

In the non-limiting embodiment shown, the computer 12 receives signals wirelessly or through an electric cord 20 from a mouse-like input device 18. By “mouse-like input device” is meant a computer mouse, a computer trackball, and other input devices having at least two click elements such as buttons and a rolling-type element for establishing a desired cursor position on the display 16. Also, joysticks are included in “mouse-like input device”.

As shown in cross-reference to FIGS. 1 and 2, the input device 18 includes a housing 22 on which is rollably mounted a ball 24 and at least two click elements 26, 28, for cursor operation and selection input to the computer 12 in accordance with principles known in the art. In the embodiment shown, the click elements 26, 28 are buttons that can be depressed, with each click element 26, 28 being associated with a respective function or set of functions that might overlap with those of the other click element but that typically are not identical to those of the other click element. A user can depress the click elements 26, 28 in accordance with principles known in the art to enter information to the processor 14 to cause the processor 14 to, e.g., open files, select entries under the cursor, etc.

In the embodiment shown in FIGS. 1 and 2, the mouse-like device 18 may include plural pressure sensors 30 that are supported on the housing 22. Three sensors 30 are shown, it being understood that two or four or more sensors can be used. The sensors 30 can be piezoelectric sensors. In any case, each sensor generates signals representative of the force being applied to the housing 22 near the sensor, and the signals from the sensors 30 may be sent to a processor 31 within the mouse-like device housing 22 or to the processor 14 of the computer 12, as set forth further below. While FIG. 1 shows that the sensors are disposed near the bottom of the housing 22, they may be disposed on or just under the top surface as well.

If desired, a fingerprint reader 32 can be included on the mouse-like device housing 22 for purposes to be shortly disclosed. The reader 32 sends signals to the processor 31 of the mouse-like input device 18 and/or to the processor 14 of the computer 12. Alternatively or in addition, the mouse-like device 22 can include a cursor positioning element such as a rotatable cursor wheel 33 that can be rotated by a user to move a cursor on a screen in accordance with principles known in the art, and that can also be used as set forth further below to establish handedness.

As also shown in FIG. 1, the computer 12 can include a wrist rest 34, and instead of or in addition to the sensors 30 of the mouse-like input device 18, pressure sensors 36 can be mounted in the wrist rest 34.

As recognized herein, the functions undertaken by the click elements 26, 28 are not hard-wired into the elements, but rather are associated with the elements in software by the operating system of the computer 12. Accordingly, to change the functions of the click elements, i.e., to establish the “handedness settings” of the elements, software can be accessed to assign a first function or set of functions to the left click element 26 and to assign a second function or set of functions to the right click element 28, and to swap the first and second function or functions as desired by the user. It is the purpose of the present invention to automatically establish the handedness settings without requiring the user to access the operating system and manually change functions between buttons.

In the preferred embodiment, this is established by sensing “resting tactile contact” of the user's fingers against the mouse-like a pointing device of the computer, or against the wrist rest. By “resting tactile contact” is meant the tactile contact that occurs when a user naturally rests a finger or fingers on a pointing device without meaning to input information (such as cursor moves) to the processor 14. As understood herein, a left-handed user typically will rest fingers on pointing devices differently than a right-handed user owing to the body's natural conformation and the at-rest orientation differences between left and right extremities.

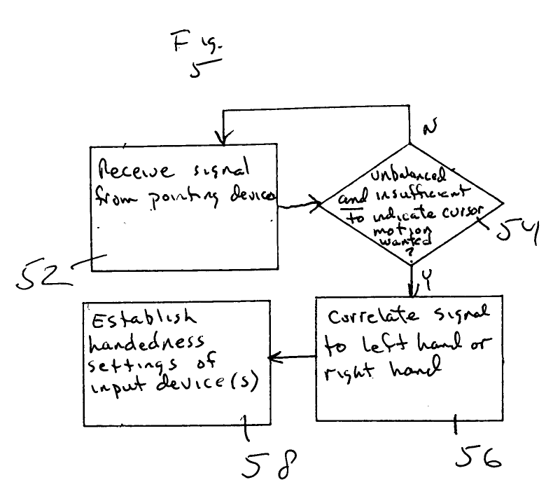

Now referring to FIG. 3, when a fingerprint reader is to be used instead of the pressure sensors, at block 38 the signals from the fingerprint reader 32 are received by one or both of the processors 14, 31 and converted to a fingerprint read signal at block 40. Moving to block 42, a fingerprint database is entered using the read signal as entering argument to find a match of the user's fingerprint. The matching entry is correlated to a left hand finger or right hand finger, with left- or right-handedness being determined based on whether a left hand finger or right hand finger is detected.

The handedness settings of the click elements 26, 28 are then established at block 44. In non-limiting illustrative implementations, this can be accomplished by automatically associating, in operating system software, more common click element functions to the right click element 28 when right handedness is determined and to the left click element 26 when left handedness is determined, or vice-versa if desired.

The finger print database that is accessed at block 42 may be contained in the computer 12 or in the mouse-like device housing 22. Or, it may be accessible over the Internet. In the latter case, a service can be provided wherein a user computer sends a fingerprint read signal to a Web server, which accesses the database to correlate the signal to left- or right-handedness and then return a message to the operating system of the computer 12, indicating left- or right-handedness. The message can be used by the operating system of the computer 12 to establish the handedness settings of the click elements 22, 24.

It is to be understood that when the handedness determination is undertaken by the processor 14 of the computer 12, the click element settings of the elements 26, 28 are dynamically established in the operating system of the computer 12. In contrast, when the processor 31 of the mouse-like device 18 undertakes the handedness determination, the processor 31 may simply define button identities to the computer processor 14 as appropriate so that operating system settings do not change, but the button identity associated with each setting is established by the processor 31 of the mouse-like device 18.

FIG. 4 shows the logic for automatically establishing handedness settings when pressure sensors are used, either the sensors 30 on the mouse-like housing 22 or the sensors 36 in the wrist rest 34. Commencing at block 46, the signals from the sensors are received. At block 48 the signals are correlated to a left hand or right hand. The correlation may be based on empirically determined rules. By way of non-limiting example, when left-most sensors indicate greater force than right-most sensors, this circumstance can be correlated to left handedness and vice-versa. Or, when upper (relative to the computer 12 or mouse-like device housing 22) sensors indicate greater force than lower sensors, this circumstance can be correlated to left handedness and vice-versa. It is to be understood that these exemplary rules are illustrative only and non-limiting. At block 50, the functions (handedness) of the click elements 26, 28 are established by, e.g., the processor 14 as appropriate based on the determination made at block 48.

FIG. 5 shows how signals from the wheel 33 in FIG. 1 can be used to determine right or left handedness in an exemplary non-limiting embodiment such that no special purpose element (such as a fingerprint reader or add-on pressure sensors) need be provided, but rather a legacy element used that has a function other than determining handedness settings. Commencing at block 52, the signals from the wheel 33 are received. At decision diamond 54, it may be determined whether the signals represent a torque on the wheel 33 but one that is of a magnitude below a threshold and/or of constant magnitude, indicating a light resting touch instead of a touch representing a desired cursor motion.

If the test at decision diamond 54 indicates a resting touch, the logic proceeds to block 56 to correlate the signal to left or right handedness. The correlation can be in accordance with empirically determined rules. By way of non-limiting example, a light touch that pushes the wheel 33 in the clockwise direction can be correlated to left-handedness, while one that pushes the wheel 33 in the counterclockwise direction can be correlated to right-handedness. At block 58, the handedness settings of the click elements 26, 28 are established in accordance with principles set forth above.

If desired, the above-described automatic establishment of click element functions (i.e., of handedness) can be selectively enabled by the user. If desired, the determinations regarding handedness set forth above can be made, but the handedness settings changed from default values or current values only upon prompting the user that a change is about to occur and receiving a confirmation signal from the user to change the settings. If further desired, the handedness settings may be automatically changed only upon user logon or elapse of a predetermined time period, e.g., only if pressure signals from the above-described sensors indicate that the user has rested his or her hand on the surface associated with the sensors (e.g., on the housing 22) longer than a threshold period.

While the particular SYSTEM AND METHOD FOR AUTOMATICALLY ESTABLISHING HANDEDNESS SETTINGS OF MOUSE-LIKE INPUT DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. It is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconcilable with the present specification and file history.

What is claimed is:

1. A method comprising:
receiving at least one signal from at least one mouse-like input device of a computer, the signal being generated when a user makes resting tactile contact with the input device; and
based at least in part on the signal, automatically establishing at least one handedness setting.

2. The method of claim 1, wherein the mouse-like input device includes at least two buttons, and the handedness settings are established for the buttons based on a signal that is generated when a user makes resting tactile contact with the mouse-like input device.

3. The method of claim 2, wherein the mouse-like input device is selected from the group consisting of mice, trackballs, and joysticks.

4. The method of claim 2, wherein the mouse-like input device includes an input device housing and plural pressure sensors supported in the housing, the sensors generating signals when a user rests a hand on the housing, the signals being used by a processor to establish handedness settings.

5. The method of claim 4, wherein the processor is in the housing, and the processor defines button identities to a computer based on the signals from the pressure sensors.

6. The method of claim 4, wherein the processor is in a computer communicating with the mouse-like input device, and the processor assigns at least one function to each button based on the signals from the pressure sensors.

7. The method of claim 1, wherein the mouse-like input device includes at least one fingerprint reader for use in correlating a fingerprint image from the reader to a left finger or right finger to establish the handedness setting.

8. The method of claim 2, wherein the mouse-like input device includes an input device housing and a cursor positioning wheel on the housing, at least some signals from the cursor-positioning wheel being used to establish the handedness setting.

9. A computer input system for inputting signals to a computer housing holding at least one processor, comprising:
a mouse-like housing;
a mouse-like pointing device on the mouse-like housing;
at least two click elements on the mouse-like housing; and
plural pressure sensors on the mouse-like housing for generating signals when a user rests a hand on the housing, the signals being useful for automatically establishing respective functions for the click element.

10. The system of claim 9, wherein the mouse-like pointing device is selected from the group consisting of mice, trackballs, and joysticks.

11. The system of claim 9, comprising a processor in the mouse-like housing, the processor defining button identities to a computer based on the signals from the pressure sensors.

12. The system of claim 9, wherein a processor is in a computer communicating with the mouse-like device, and the processor assigns at least one function to each button based on the signals from the pressure sensors.

13. The system of claim 9, wherein the mouse-like housing supports at least one fingerprint reader for use in correlating a fingerprint image from the reader to a left finger or right finger to establish the handedness setting.

14. A mouse-like input device including at least one fingerprint reader useful for correlating a fingerprint image from the reader to a left finger or right finger to establish at least one handedness setting for the input device.

15. A service, comprising:
receiving a fingerprint signal generated from at least one mouse-like input device; and
returning to a user computer associated with the mouse-like input device a signal representing “left” or “right” to facilitate establishing handedness settings for click elements associated with the mouse-like input device.

16. A computer program device executable by a processor, the program device embodying means for automatically establishing at least one handedness setting for a mouse-like input device based at least in part on at least one signal that is generated when a user makes tactile contact with the mouse-like input device.

17. The device of claim 16, wherein the mouse-like input device has plural pressure sensors generating signals at least when a user rests a hand on the device, the signals being used by the means for automatically establishing.

18. The device of claim 16, wherein the mouse-like input device includes a fingerprint reader outputting signals useful to the means for automatically establishing.

19. The device of claim 16, wherein the mouse-like input device includes a cursor positioning wheel outputting signals useful to the means for automatically establishing.

20. A computer wrist rest comprising a wrist rest body and plural pressure sensors disposed in the body and outputting signals representative of a user resting a portion of the user's body on the wrist rest, the signals being useful in determining handedness.

21. The wrist rest of claim 20, further comprising a processor receiving the signals and establishing functions of at least two click elements in response thereto.

22. The wrist rest of claim 21, wherein the click elements are on a mouse-like input device.

23. A computer input system for inputting signals to a computer housing holding at least one processor, comprising:
a mouse-like housing;
at least two click elements on the mouse-like housing; and
a cursor positioning element on the mouse-like housing and generating signals useful by a processor for automatically establishing respective functions for the click element.

24. The system of claim 23, wherein the processor is in the housing.

25. The system of claim 23, wherein the processor is in the computer.
